(19) United States
(12) Patent Application Publication
(10) Pub. No.: US 2013/0006856 A1
(43) Pub. Date: Jan. 3, 2013

(54) FLEXIBLE PAYMENT INSTRUMENT

(75) Inventor: Norihiro Edwin Aoki, Sunnyvale, CA (US)

(73) Assignee: eBay Inc., San Jose, CA (US)

(21) Appl. No.: 13/173,372

(22) Filed: Jun. 30, 2011

(51) Int. Cl. G06Q 40/00

(52) U.S. Cl. 705/41

(57) ABSTRACT

Systems and methods are provided for transactions using a flexible payment instrument. A method according to an embodiment comprises allowing a giver to obtain a flexible payment instrument and specify one or more arbitrarily complex conditions for use of the flexible payment instrument on a per-payment-instrument basis in connection with one or more transactions. The method also comprises linking, by a remote location, the flexible payment instrument to an account of the giver maintained at the remote location, wherein the giver provides the flexible payment instrument to a recipient issued with the condition(s) specified by the giver for use by the recipient in connection with the one or more transactions. The method further comprises comparing, at the remote location, the condition(s) specified by the giver with transaction information details upon the use by the recipient of the flexible payment instrument in connection with the transaction(s). If the transaction information details are in compliance with the condition(s) specified by the giver, authorizing the transaction(s) using the flexible payment instrument.

### BACKGROUND

1. Technical Field

Embodiments of the present disclosure generally relate to transactions, and more particularly, to methods and systems for transactions using flexible payment instruments.

2. Related Art

In recent years, the market for gift cards has exploded. A traditional gift card is generally a stored value instrument, which records a prepaid balance that has been loaded onto the card by a purchaser and then depleted upon use. Shoppers can use the prepaid gift cards at both online and offline retailers, where they can use them like cash to purchase items of their choosing. But while gift cards may provide shoppers with some choice, they may still be inefficient in certain aspects. For example, millions of dollars are routinely lost as the value of gift cards may be wasted when left unused.

### SUMMARY

As will be further described herein in relation to one or more embodiments, methods and systems are provided for transactions using a flexible payment instrument with rule-based constraints. When a purchaser or giver obtains a flexible payment instrument such as a smart gift card, the giver may set constraints for the use of the flexible payment instrument. The giver may give the flexible payment instrument to a recipient, which the recipient may use for paying for goods, applications and/or services pursuant to the set of constraints set by the giver of the flexible payment instrument. As such, unlike conventional gift cards, the giver may set certain constraints for the use of the payment instrument. Advantageously, the flexible payment instrument may use a pre-paid model, a post-purchase model and/or may be of dynamic value.

In accordance with an embodiment of the disclosure, a method comprises allowing a giver to obtain a flexible payment instrument and specify one or more arbitrarily complex conditions for use of the flexible payment instrument on a per-payment-instrument basis in connection with one or more transactions. The method also comprises linking, by a remote location, the flexible payment instrument to an account of the giver maintained at the remote location, wherein the giver provides the flexible payment instrument to a recipient issued with the condition(s) specified by the giver for use by the recipient in connection with the one or more transactions. The method further comprises comparing, at the remote location, the condition(s) specified by the giver with transaction information details upon the use by the recipient of the flexible payment instrument in connection with the transaction(s). If the transaction information details are in compliance with the condition(s) specified by the giver, authorizing the transaction(s) using the flexible payment instrument.

In accordance with another embodiment of the disclosure, a payment system comprises a payment instrument linked to a giver's account maintained at a remote location. The system also comprises one or more processors and one or more memories adapted to store a plurality of machine-readable instructions which when executed by the one or more processors are adapted to cause the system to: allow a giver to set up one or more arbitrarily complex conditions on use of the payment instrument on a per-payment-instrument basis in connection with one or more transactions; and authorize the transaction(s) if the transaction(s) are in compliance with the one or more conditions set up by the giver of the payment instrument.

In accordance with another embodiment of the disclosure, a non-transitory computer readable medium comprises stored computer readable instructions which when executed by a processor, cause the processor to: allow a giver to set up one or more arbitrarily complex restrictions on a use of a payment instrument on a per-payment-instrument basis in connection with one or more transactions; and authorize the transaction(s) if the transaction(s) are in compliance with the one or more restrictions set up by the giver of the payment instrument.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a flow diagram illustrating a life cycle of a flexible payment instrument according to an embodiment of the present disclosure.

FIG. 2 is a flow diagram illustrating a method for transactions using a flexible payment instrument according to an embodiment of the present disclosure.

FIG. 3 is a block diagram illustrating a system for flexible payment instruments according to an embodiment of the present disclosure.

Like element numbers in different figures represent the same or similar elements.

### DETAILED DESCRIPTION

In accordance with one or more embodiments described herein, methods and systems are provided for transactions such as financial transactions using a flexible payment instrument. A flexible payment instrument according to one or more embodiments may be in the form of a smart gift card, a coupon, a voucher, a code, a barcode, an RFID tag, or any other delivery mechanism, or it may be built off of applications running on a user device such as a mobile phone, a POS terminal, a computing device, or any other device.

Recipients of the flexible payment instrument may select to use the flexible payment instrument in connection with one or more transactions, for example, to pay for goods, applications, and/or services (“items”). In that regard, the flexible payment instrument allows a recipient to purchase items, but only those that satisfy certain conditions, rules, restrictions, or constraints (“conditions”) set by the giver or purchaser of the flexible purchase instrument. For example, the flexible payment instrument may be issued with certain rule-based conditions set by the giver including, but not limited to: specifying the purchase of a particular item or classes of items for which a flexible payment instrument may be used with or without regard to the merchant at which the purchase occurs; setting a specific time limit, setting a specific merchant or class of merchants, setting a specific geographical location, area or limit, setting an exact selling price of an item; setting limits based on a class of items with a maximum per item or total price; setting limits on spending without requiring the full spend of the flexible payment instrument, and/or any other appropriate conditions.

The flexible payment instrument may be linked to a giver's account maintained at a remote location such that the remote location may authorize the use of the flexible payment instrument in connection with a transaction if the transaction complies with the conditions set by the giver for use of the flexible payment instrument. In one or more embodiments, the remote location may charge the giver's account upon authorization of a transaction in real time. In other embodiments, the use of a flexible payment instrument in connection with a transaction may be authorized only upon approval by the giver on a case by case basis. As such, the flexible payment instrument with rule-based conditions provides significantly more capabilities than conventional gift cards while using a prepaid or a post-purchase model.

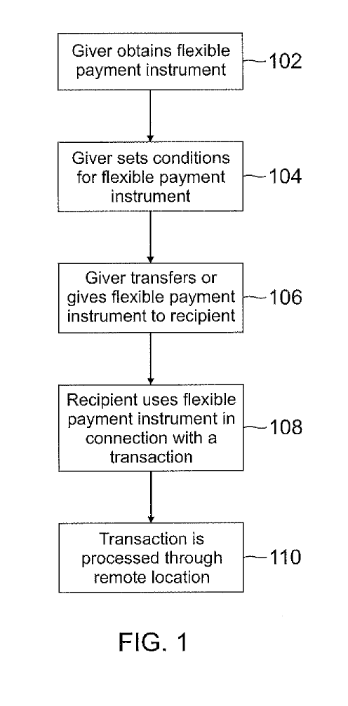

Referring now to the drawings wherein the showings are for purposes of illustrating embodiments of the present disclosure only, and not for purposes of limiting the same, FIG. 1 is a flow diagram illustrating a life cycle of a flexible payment instrument according to an embodiment of the present disclosure.

In block 102, a giver may obtain a flexible payment instrument. The giver may obtain the flexible payment instrument in any number of manners including, for example, online via a website, downloading on a user device, at any physical location for conducting business (profit or non-profit) from a business entity or seller such as a merchant or service provider including, for example, a restaurant, a retail store, a service facility such as a gym, a spa, an office, or any other type of business that provides goods and/or services, or at any appropriate Point of Sale (POS) location. In one or more embodiments, the giver may obtain flexible payment instruments on a self-operated basis at a POS location, for example, at vending machines, ATMs, laundromats, ticket dispensers, etc.

It should be noted that the flexible payment instrument may be issued by any entity including, for example, any business entity or seller such as a merchant or service provider, or by a payment processor or payment service provider, financial institution, or the like.

In block 104, the giver may set up or specify conditions for use of the flexible payment instrument. The giver may set conditions for the flexible payment instrument in any number of manners including, for example, by filling out paperwork, on a website, or on a downloaded application for specifying the conditions as chosen by the giver.

In one or more embodiments, the conditions may be built-in or preloaded on the flexible payment instrument. For example, if the flexible payment instrument is to be used for a particular airline such as Southwest®, one or more conditions may be preloaded.

In other embodiments, a giver may be provided with an identifier such as a number, a symbol, or a pin associated with the flexible payment instrument. The giver may then enter the identifier, for example online, on a website, or on a downloaded application, and be given an option to enter and set conditions for use of the flexible payment instrument. In embodiments where the flexible payment instrument is downloadable, the giver may set conditions at the time of downloading or obtaining the flexible payment instrument.

According to one or more embodiments, the flexible payment instrument may be prepaid, that is, the giver may pay for a specific value of the gift at the time of obtaining the flexible payment instrument. Alternatively, the flexible payment instrument may be postpaid, that is, the giver may specify a maximum value for the gift, but may not have to pay until the flexible payment instrument is redeemed. In that case, the flexible payment instrument may be of dynamic value, that is, the redemption value may be less than the specified maximum value for the gift.

In block 106, the giver may transfer or give the flexible payment instrument to a recipient. For example, the giver may transfer or give the flexible payment instrument to the recipient in the form of a physical card, an email, a token, or in any other appropriate manner.

In block 108, the recipient may select to use the flexible payment instrument in connection with one or more transactions. For example, the recipient may select to use the flexible payment instrument to pay for one or more items at an applicable merchant such as a retail store instead of, for example, using a credit card or cash.

In block 110, the transaction(s) may be processed via a remote location. For example, a business entity such as a merchant may process the transaction for payment through a payment processor.

The remote location may be a payment service provider or payment processor, a financial institution, or a respective intermediary adapted to facilitate transaction routings between users at multiple POS locations and the remote location. In one or more embodiments, the remote location may be a payment service provider such as PayPal®, Inc. or eBay®, Inc. of San Jose, Calif.

It should be noted that, in one or more embodiments, the issuer of flexible payment instruments may or may not be the same entity as the remote location (e.g., a payment processor). For example, business entities or sellers may issue flexible payment instruments and allow a giver to set conditions for the flexible payment instruments while a remote location, a separate entity, may process the transaction for payment. In other embodiments the remote location (e.g., a payment processor) may be the same entity as the issuer of the flexible payment instrument.

As such, according to one or more embodiments, flexible payment instruments provide the giver with the ability to select the kind of gift the giver wants the recipient to have. The giver may set conditions for use of the flexible payment instruments in an independent manner according to the giver's wishes. That is, the giver has an effect (either a one-time effect or ongoing) on the use of the flexible payment instrument in ways traditional gift cards do not. Thus, the flexible payment instrument according to one or more embodiments offers the giver the ability to augment the capabilities of the flexible payment instrument by setting certain conditions on the gift, which become part of the flexible payment instrument, but still allows the recipient to conveniently select the flexible payment instrument in connection with one or more transactions.

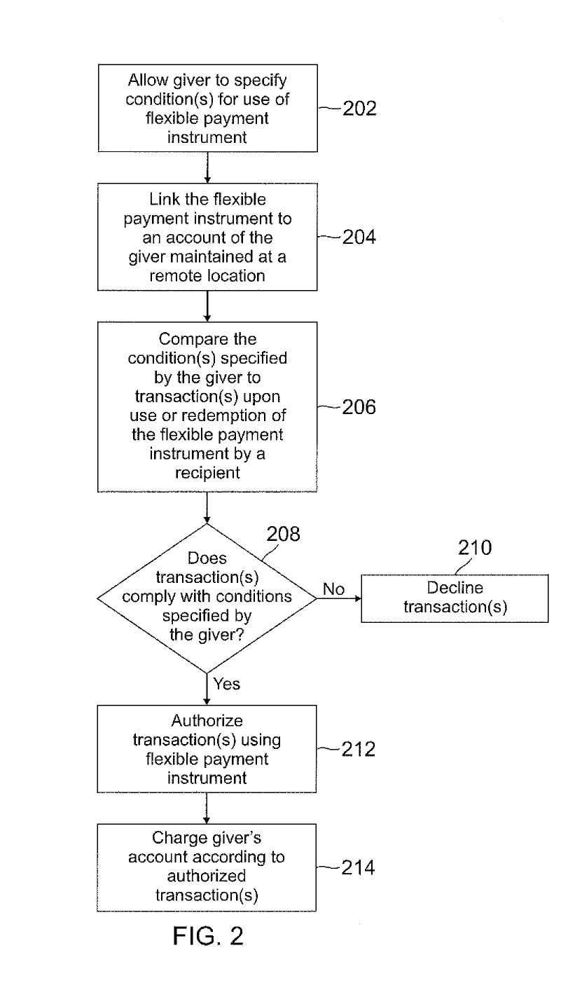

FIG. 2 is a flow diagram illustrating a method for transactions using a flexible payment instrument according to an embodiment of the present disclosure.

In block 202, the giver is allowed to specify conditions for use of the flexible payment instrument. Routinely, a giver may decide to obtain a flexible payment instrument such as a smart gift card to give as a gift to a recipient and set conditions for its use as described above with respect to the embodiment of FIG. 1.

In block 204, the flexible payment instrument may be linked to an account of the giver maintained at a remote location as will be described in more detail below.

In block 206, upon a recipient's selection to use or redeem the flexible payment instrument in connection with one or more transactions, for example, to pay for one or more items, the conditions set by the giver may be compared with transaction information details received at the remote location.

In block 208, if the transaction information details do not comply with the conditions set by the giver for use of the flexible payment instrument, the transaction(s) is declined in block 210. If the transaction information details comply with the conditions set by the giver for use of the flexible payment instrument, the transaction(s) is authorized in block 212.

In that regard, the transaction(s) may be authorized in real time upon compliance with the conditions set by the giver. Alternatively, the transaction(s) may be authorized only upon approval by the giver on a case by case basis. In that case, when a recipient attempts to use a flexible payment instrument in connection with a transaction, the remote location may interact with the giver, for example, the remote location may call, email or text the giver to get approval prior to authorization. For example, where a condition of a flexible payment instrument indicates that it may only be used for the purchase of textbooks, but the recipient attempts to use the flexible payment instrument for books other than textbooks (e.g., comic books), then the remote location may interact with the giver to obtain approval before authorizing the transaction.

In block 214, the remote location may charge the account of the giver according to the authorized transaction(s). As such, according to one or more embodiments of the present disclosure, the remote location such as a payment processor may have the ability to authorize payments based on the transaction information details at the time of the recipient's use or redemption of the flexible payment instrument. This attribute allows flexible payment instruments to be postpaid and of dynamic value, aspects that may be impossible with conventional gift cards. Upon redemption of the flexible payment instrument, the payment processor may validate, verify and enforce the flexible payment instrument.

While a conventional gift card is generally a stored value instrument, which records a balance that has been loaded onto the card by a purchaser and then depleted upon use, a flexible payment instrument according to one or more embodiments, by contrast, may operate more like a credit card, reflecting a preapproval of a certain kind of transaction. Because the actual transaction authorization may be made in real time by the remote location, e.g., by the payment processor, unlike a conventional gift card, the flexible payment instrument according to one or more embodiments may be capable of handling complex and detailed authorization rules.

A real world example of the use of flexible payment instruments may involve a scenario as follows: Bob wants to buy a gift for his friends John and Mary, who are getting married. Bob could purchase a gift from their registry, but John and Mary did not prepare one. So Bob instead purchases a smart gift card for a one-night hotel stay for the couple's honeymoon in Hawaii. Advantageously, Bob does not pay for the smart gift card at the time Bob purchases the smart gift card. Bob may take the smart gift card, then figure out what limits to set up such as what amount or value Bob wants the smart gift card to have. Bob does not know where John and Mary are going to be staying, but the smart gift card allows John and Mary to use it at any hotel. To protect Bob's pocketbook, he also limits the value of his gift card to up to $250. John and Mary then have the potential to spend up to $250 for a one-night hotel stay in Hawaii. Notably, Bob has not spent any amount of money yet. The recipients John and Mary may then decide to stay in a budget hotel and although the smart gift card would allow them to charge up to $250, a lesser amount may be charged, for example, $100 for a one-night stay in the budget hotel. Because the smart gift card is not just a stored value card, the smart gift card may only be good for the amount charged, e.g., $100. That is, the smart gift card has a value that depends on the conditions set by the giver. Also, the smart gift card may be a one-time use card in one or more embodiments. In other embodiments, the giver may set the conditions so that the smart gift card may be used more than one time up to a predefined limit.

As discussed above, behind the scenes, the smart gift card is a form of a flexible payment instrument that may be linked to a remote location or a fixed payment instrument, such as a bank account, a credit card, a PayPal® account, or any other appropriate payment processor account. In this example, the smart gift card is issued with a predefined limit of $250 and a rule that indicates that it may be used only for hotel accommodations. When John and Mary pay for their lodging, they provide the hotel with the smart gift card. When the hotel authorizes the transaction with the remote location such as the payment processor, the payment processor compares the supplied transaction information details (a hotel room) and transaction amount with the pre-stored rules, and authorizes or declines the transaction. If authorized, the payment processor then charges Bob's fixed payment instrument for the value of the hotel room, which could be less than Bob's predefined limit of $250, for example, only $100 for a budget hotel.

The rules governing the flexible payment instrument may be arbitrarily complex, depending on, for example, information provided by a merchant. Rules may apply to categories of items (books, hotels, airfare, car parts, food, etc.) or for specific items (e.g., identified by name or UPC/EAN). They may also limit purchases to specific stores, geographic locations, quantities, or amounts. Thus, it is possible to give a flexible payment instrument that allows for the purchase of a given item at any store, or a range of items at a specific store.

In one or more embodiments, the flexible payment instrument may allow the giver to approve each gift. For example, approval may be provided in a manner similar to a payment processor account such as a PayPal® account that is used for student accounts, i.e., each purchase by a student is approved upon use. Moreover, these rules may be combined in arbitrary ways so that a recipient may receive, for example, up to $50 of food, or up to $100 of books, in order to encourage reading.

According to one or more embodiments, a flexible payment instrument may afford the current behavior of gift cards, but in a postpaid model. It is estimated that millions of dollars' worth of issued conventional gift cards remain unused, which has led to new businesses like Plastic Jungle™ (a website where traditional gift cards may be bought, sold or exchanged). However, even with websites such as Plastic Jungle™, the gift giver has already paid the initial expense to purchase the gift card, whether or not the recipient ever uses it. In one or more embodiments of the present disclosure, by linking a flexible payment instrument to a remote location, e.g., a fixed payment system, and performing an actual capture operation at the time of obtaining the flexible payment instrument, the purchaser of the flexible payment instrument does not actually pay for the flexible payment instrument until the card is used or redeemed, making this type of flexible payment instrument more attractive to the giver.

According to one or more embodiments, a transition from a stored value card to a flexible payment instrument such as a smart gift card may introduce a credit aspect to a transaction, such that payment processors, e.g., PayPal®, which may have existing risk and credit models, may become an important asset in the implementation of the solution. Catalog and inventory management tools, particularly those that allow for the matching of items to rule sets, may also be important for one or more embodiments. For example, an 80 GB iPod® is an example of an iPod®; an iPod® is a type of media player; therefore, the purchase of an 80 GB iPod® satisfies a rule that a smart gift card be used for the purchase of a media player.

In one or more embodiments, flexible payment instruments may be used across various marketplaces. In an example, they may be used across various properties such as eBay® properties including marketplaces and Shopping.com® to allow buyers to purchase non-exact items; for example, an eBay® Gift Card may be used for the purchase of “an iPod Nano®)”, which may refer to any of a number of running auctions, not just those for a particular auction or for a particular value.

There may exist several conventional payment instruments that may be tied to particular transaction types. Most common among these are electronic food stamps, which are vouchers that can only be used for certain approved food and household expenses. Other payment instruments may be tied to health, dependent, or transportation accounts and may only be used to purchase certain classes of items such as pharmaceuticals or train tickets. None of these mechanisms, however, provide the end user with the ability to specify arbitrarily complex rules and conditions for the items, nor do they provide, for example, for a dynamic payment system where the value of the card can be defined at runtime based on certain rules. In an example where an insurance company issues conventional health savings credit cards, the insurance company may set rules so that the health savings credit cards can only be used in pharmacies and medical merchants. All such health savings credit cards issued by the insurance company have the same restrictions. However, according to one or more embodiments of the present application: a) a giver is able to set rules that are arbitrarily complex, and b) the giver may specify rules on a per-payment-instrument basis rather than, for example, on an issuer or processor basis. As such, embodiments of the present application allow for much more interesting use cases, for example, a health card for diabetics may allow them to purchase certain kinds of food, whereas a health card for non-diabetics may not.

Additionally, one or more embodiments of the present disclosure may use a real-time authorization system provided by the remote location such as a payment processor, and do not rely solely on precategorized merchants or items. For instance, Amazon.com® and iTunes® may both incorporate a “gift this item” option on their sites. However, the former system is advisory only; the recipient receives a normal gift voucher with a link to the item, but the recipient can purchase any item with his or her voucher (similar to a normal gift certificate or cash for one item at one value). The latter system is a specific downloadable link, for example, for a particular song similar to going to a store and buying a specific item. A redemption code may be used just for the particular song, but it does not provide any of the flexibility of a flexible payment instrument nor a rules-based system (e.g., allowing a giver to set up conditions) as described according to one or more embodiments herein.

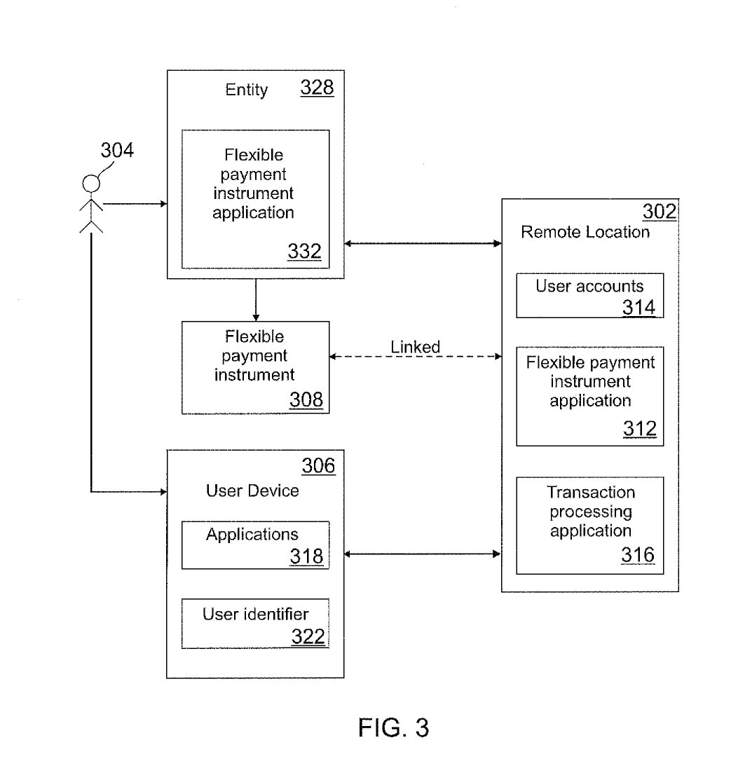

Referring now to FIG. 3, a system for flexible payment instruments is illustrated according to an embodiment of the present disclosure.

As described above according to one or more embodiments, a gift purchaser or giver 304 may wish to obtain a flexible payment instrument such as a smart gift card to give as a gift to a recipient. Gift giver 304 may obtain the flexible payment instrument in various ways including, for example, a physical flexible payment instrument 308 issued by an entity 328 such as a business entity or seller at a business location, online, or downloaded via a user device 306. It should be noted that a remote location 302 may also issue flexible payment instruments, which may be obtained, for example, online, or downloaded via user device 306. In one or more embodiments, the flexible payment instrument may include a processor as part of the flexible payment instrument itself. The flexible payment instrument (whether it is in the form of a physical flexible payment instrument 308, or a flexible payment instrument downloaded via user device 306) may be linked to an account of gift giver 304 maintained at remote location 302.

Entity 328 or remote location 302 may implement a flexible payment instrument application 332 or 312 to enable givers to obtain a flexible payment instrument, for example, online, via user device 306, or physically, to create and select a flexible payment instrument.

Remote location 302 may maintain a plurality of user accounts 314, each of which may include account information associated with specific users such as gift giver 304. For example, in one embodiment, account information may include private or confidential information of a user as account numbers, passwords, credit/debit card information, bank information, or other information that may be used to facilitate online or other types of transactions between remote location 302 and users such as gift giver 304.

User device 306 may include one or more processors coupled to one or more memories configured to process creation and/or selection of flexible payment instruments to be downloaded by giver 304

User device 306 may be implemented using any appropriate combination of hardware and/or software configured for wired and/or wireless communication over a network. For example, in one embodiment, user device 306 may be implemented as a mobile device of gift giver 304 in communication with a network such as the Internet or another network. In other embodiments, user device 306 may be implemented as a personal computer, wireless telephone, personal digital assistant (PDA), key fob, smart phone, smart card, notebook computer, game console, digital video recorder (DVR), and/or other types of computing devices. Furthermore, user device 306 may be enabled for Near Field Communication (NFC), Bluetooth, online, infrared communications and/or other types of communications.

User device 306 may be configured to download, install, and/or run various applications as may be desired in particular embodiments to provide desired features to user device 306. For example, in various embodiments, applications 318 may include security applications for implementing client-side security features, programmatic client applications for interfacing with appropriate application programming interfaces (APIs) over a network, or other types of applications.

User device 306 may further include one or more user identifiers 322 that may be implemented, for example, as operating system registry entries, cookies associated with a browser application, identifiers associated with hardware of user device 306, or other appropriate identifiers. In one embodiment, a user identifier may be used by remote location 302 to associate user device 306 or gift giver 304 with a particular account maintained by remote location 302.

According to an embodiment, flexible payment application 312 of remote location 302 may be configured to interact with user device 306 so that gift giver 304 (via user device 306) is enabled to download applications. Gift giver 304 may first register, prepare or otherwise sign up to use flexible payment instrument application 312 implemented by remote location 302.

Remote location 302 may provide a transaction processing application 316 that may be configured to receive transaction information details upon a recipient's selection to use or redeem a flexible payment instrument. In an embodiment, transaction processing application 316 may process the transaction information details in connection with the particular flexible payment instrument. In that regard, remote location 302 may recognize each flexible payment instrument linked to remote location 302 by a unique identifier for both internal and external identification. The flexible payment instrument identifier may be used by remote location 302 to associate user device 306 (or correspondingly giver 304) with a particular account maintained by remote location 302. In particular, the identifier may be linked to the particular flexible payment instrument and/or the giver's identification information maintained at the remote location. The identifier may include, for example, a name, icon, word, symbol, label, phrase, name or any other appropriate identifier. As described above according to one or more embodiments, the identifier may be provided and entered by the gift giver at the time the gift giver obtains and sets conditions for the flexible payment instrument.

When a recipient selects to use the flexible payment instrument in connection with a transaction (e.g., instead of paying for an item with cash or a transaction card), the transaction information details are transmitted or sent to remote location 302. Transaction information details may include, for example, a price, a quantity, a geographic location, a flexible payment instrument identifier, etc. Once the transaction information details are received at remote location 302, the flexible payment instrument may be linked to the gift giver's identification and account information maintained at remote location 302.

The transaction may be confirmed or rejected depending on whether the received transaction information details match conditions set by gift giver 304, wherein gift giver 304 has an account maintained at remote location 302. Once confirmed, remote location 302 may facilitate and confirm the transaction.

User device 306, flexible payment instrument 308, remote location 302, for example a payment service provider, as well as any computing device that may be located at a POS location in entity 328 may each include one or more servers, processors, memories, and other appropriate components for executing instructions such as program code and/or data stored on one or more computer readable mediums to implement the various applications, data, and methods described herein. For example, such instructions may be stored in one or more computer readable mediums such as memories or data storage devices internal and/or external to various components of the system, and/or accessible over a network, which may be implemented as a single network or a combination of multiple networks. For example, in various embodiments, a network may include the Internet or one or more intranets, landline networks, wireless networks, and/or other appropriate types of networks.

It should be understood that identification information for a particular gift giver or user device may be set during pre-registration with the remote location. According to one or more embodiments, it is assumed that the gift giver has previously registered with the remote location, for example, to open an account. In this regard, it will be appreciated that the gift giver may have previously provided account information to the remote location, for example, via a written application, online, or over a network through, for example, a secure connection between user device 306 and remote location 302.

Where applicable, various embodiments provided by the present disclosure may be implemented using a server, hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more non-transitory computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although financial transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A method for transactions using a flexible payment instrument comprising:
allowing a giver to obtain the flexible payment instrument and specify one or more arbitrarily complex conditions for use of the flexible payment instrument on a per-payment-instrument basis in connection with one or more transactions;
linking, by a remote location, the flexible payment instrument to an account of the giver maintained at the remote location, wherein the giver provides the flexible payment instrument to a recipient issued with the condition(s) specified by the giver for use by the recipient in connection with the one or more transactions;
comparing, at the remote location, the condition(s) specified by the giver with transaction information details upon the use by the recipient of the flexible payment instrument in connection with the transaction(s); and
if the transaction information details are in compliance with the condition(s) specified by the giver, authorizing the transaction(s) using the flexible payment instrument.

2. The method of claim 1, wherein the allowing further comprises allowing the giver to obtain the flexible payment instrument issued from a business entity or from the remote location.

3. The method of claim 1, wherein the authorizing further comprises authorizing the transaction(s) in real time and charging the account of the giver at the remote location in connection with the authorized transaction(s).

4. The method of claim 1, wherein the authorizing further comprises allowing the giver to approve each use of the flexible payment instrument before the authorizing.

5. The method of claim 1, wherein the allowing further comprises allowing the giver to specify a spending amount limit, one or more items or class of items, a specific merchant or class of merchants, a time limit, a one-time use, approval before each use, and/or a geographical limit.

6. The method of claim 1, further comprising allowing the flexible payment instrument to be prepaid, postpaid or of dynamic value.

7. The method of claim 6, wherein allowing the flexible payment instrument to be postpaid further comprises allowing the giver to pay for the flexible payment instrument according to a value of the authorized transaction(s) upon the recipient's redemption of the flexible payment instrument in connection with the authorized transaction(s).

8. The method of claim 6, wherein the value of the authorized transaction(s) is less than a spending amount limit specified by the giver.

9. The method of claim 1, wherein the condition(s) are built-in or preloaded in the flexible payment instrument.

10. The method of claim 1, further comprising:
providing the giver an identifier associated with the flexible payment instrument; and
providing the giver an option to specify the condition(s) for the flexible payment instrument associated with the identifier.

11. The method of claim 1, further comprising:
allowing the giver to download the flexible payment instrument on a user device; and
providing the giver an option to specify the condition(s) for the flexible payment instrument on the downloaded flexible payment instrument.

12. The method of claim 1, wherein the flexible payment instrument further comprises a gift card, a coupon, a voucher, a code, a barcode, an RFID tag, or an application on a user device comprising a mobile device, a POS terminal or a computing device.

13. The method of claim 1, wherein the remote location further comprises a payment service provider, a financial institution, or a respective intermediary adapted to facilitate transaction routings between users at multiple POS locations and the remote location.

14. A payment system comprising:
a payment instrument linked to a giver's account maintained at a remote location;
one or more processors; and
one or more memories adapted to store a plurality of machine-readable instructions which when executed by the one or more processors are adapted to cause the system to:
allow a giver to set up one or more arbitrarily complex conditions on use of the payment instrument on a per-payment-instrument basis in connection with one or more transactions; and
authorize the transaction(s) if the transaction(s) are in compliance with the one or more conditions set up by the giver of the payment instrument.

15. The payment system of claim 14, wherein the plurality of instructions are further adapted to: charge, by the remote location, the giver's account according to the transaction(s).

16. The payment system of claim 14, wherein the plurality of instructions are further adapted to: authorize the transaction(s) in real time.

17. The payment system of claim 14, wherein the payment instrument further comprises a gift card, a coupon, a voucher, a code, a barcode, an RFID tag, or an application on a user device comprising a mobile device, a POS terminal or a computing device.

18. A non-transitory computer readable medium on which are stored computer
readable instructions and, when executed by a processor, cause the processor to:
allow a giver to set up one or more arbitrarily complex restrictions on a use of a payment instrument on a per-payment-instrument basis in connection with one or more transactions; and
authorize the transaction(s) if the transaction(s) are in compliance with the one or more restrictions set up by the giver of the payment instrument.

19. The computer readable medium of claim 18, wherein the stored computer readable instructions further cause the processor to:
charge a giver's account upon redemption of the payment instrument according to the transaction(s).

20. The computer readable medium of claim 18, wherein the stored computer readable instructions further cause the processor to:
allow the flexible payment instrument to be prepaid, postpaid or of dynamic value.
